(19) United States
(12) Patent Application Publication
(10) Pub. No.: US 2011/0120736 A1
(43) Pub. Date: May 26, 2011

(54) FIRE SAFETY APPARATUS FOR HIGH-PRESSURE GAS STORAGE SYSTEM

(75) Inventors: Hoon Hui Lee, Seoul (KR); Ki Ho Hwang, Gyeonggi-do (KR); Hyung Ki Kim, Seoul (KR); Sang Hyun Kim, Gyeonggi-do (KR)

(73) Assignees: HYUNDAI MOTOR COMPANY, Seoul (KR); KIA MOTORS CORPORATION, Seoul (KR)

(21) Appl. No.: 12/752,655

(22) Filed: Apr. 1, 2010

(30) Foreign Application Priority Data
Nov. 24, 2009 (KR) 10-2009-0114229

(51) Int. Cl. A62C 3/06

(52) U.S. Cl. 169/66

(57) ABSTRACT

The present invention provides a fire safety apparatus for a high-pressure gas storage system which can suitably ensure the fire safety of the high-pressure tank. Preferably, a flame transfer member having superior flammability is provided outside the high-pressure tank having a tank valve on a first end thereof. The flame transfer member extends a second end of the high-pressure tank to the tank valve, so that when a fire occurs, the flame transfer member rapidly burns creating flames and transfers heat from the origin of the fire to a PRD (pressure relief device) provided on the tank valve.

### CROSS-REFERENCE TO RELATED APPLICATION

This application claims under 35 U.S.C. §119 (a) the benefit of Korean Patent Application No. 10-2009-0114229 filed Nov. 24, 2009, the entire contents of which are incorporated herein by reference.

### BACKGROUND

a Technical Field

The present disclosure relates, generally, to a fire safety apparatus for a high-pressure gas storage system. More particularly, in preferred embodiments, the present invention is directed to a fire safety apparatus for suitably ensuring the safety of a high-pressure gas tank when a fire occurs.

b Background Art

Generally, fuel storage systems for high pressure gas are used in natural gas vehicles or fuel cell vehicles. Preferably, the systems include a high-pressure tank (or high-pressure gas tank) which can store high-pressure gas.

Such a high-pressure tank is preferably provided with a pressure relief device (PRD) which is suitably configured such that when a fire occurs and the temperature of the tank exceeds a predetermined temperature, gas is safely discharged from the high-pressure tank to prevent the tank from exploding.

To respond to this, in the case of fuel storage systems for fuel cell vehicles using hydrogen gas as fuel, for example as shown in FIG. 1, a PRD is typically installed on a tank valve which is suitably provided on an opening of a hydrogen storage tank.

FIG. 1 shows views of a high-pressure hydrogen storage system for fuel cell vehicles and an enlargement of a PRD provided on a tank valve of the storage system. FIG. 2 is an exemplary sectional view showing the operation of a PRD 3 used in a tank valve 2 of a typical high-pressure gas storage system.

As shown in FIG. 2, if a fire occurs inside a vehicle or outside or nearby the vehicle, when the vicinity of the PRD 3 is heated to about 110° C. by heat generated from the fire, a fusible metal piece 3a which is installed in the PRD 3 is fused to discharge high-pressure gas from the high-pressure gas tank 1.

In the conventional technique, if a relatively large fire occurs and covers the entirety of the vehicle or the fuel storage system, because sufficient heat is supplied to the PRD 3, it can be suitably operated before the high-pressure gas tank 1 explodes, thus safely discharging gas therefrom.

However, if a local fire occurs in a portion of the vehicle and flames are applied to only a portion of the high-pressure gas tank 1, heat sufficient to operate the PRD 3 may not be suitably transferred thereto.

Accordingly, in this case, there is a problem in that before the PRD 3 is operated by sufficient heat, the high-pressure gas tank 1 may be suitably damaged and thus be exploded by the heat.

Further, a likelihood of the high-pressure gas tank 1 exploding increases as the size of the high-pressure gas tank 1 increases. Thus a vehicle, for example a bus or the like, which uses a high-pressure gas tank having a large capacity, a likelihood of the high-pressure gas tank exploding is suitably increased.

Accordingly, techniques which rapidly transfer heat to the PRDs of existing high-pressure gas storage systems have been developed.

U.S. Pat. No. 6,382,232, incorporated by reference in its entirety herein, is directed to a fuse cord which could be easily burned by heat or flames that is disposed on a high-pressure gas tank in various manners. A bulb type PRD is suitably provided on an opening of the high-pressure gas tank and is configured such that it is operated to discharge gas from the tank by heat generated when the fuse cord burns.

However, in the 6,382,232 patent, the thermal capacity of the fuse cord is not sufficient, and the reliability of operation of the PRD deteriorates, if only the fuse cord is used as a heat transfer means. Accordingly, an initial explosive may be provided around the PRD. In this case, the PRD is operated in such a way that flames transferred through the fuse cord break the PRD. However, the initial explosive cannot be applied to a PRD using fusible metal.

Another conventional technique comprises a heat pipe having superior heat transfer coefficient that is disposed around a high-pressure gas tank such that heat is reliably transferred to a PRD to operate it and remove gas from the tank even when a confined fire occurs, as disclosed in U.S. Pat. No. 5,848,604, incorporated by reference in its entirety herein.

The U.S. Pat. No. 5,848,604 teaches that the heat pipe is in direct contact with the air, and thus the heat transfer efficiency may be reduced. Accordingly, under conditions of wind or low temperature, the reliability of the operation of the PRD is considerably deteriorated.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention provides a fire safety apparatus for a high-pressure gas storage system in which a flame transfer member having superior flammability is preferably provided outside the high-pressure tank of the high-pressure gas storage system, so that a PRD can be suitably reliably operated even when a confined fire occurs, thus preventing the high-pressure gas tank from exploding, thereby suitably ensuring the fire safety of the high-pressure gas storage system.

In preferred embodiments, the present invention provides a fire safety apparatus for a high-pressure gas storage system, preferably including: a flame transfer member provided outside a high-pressure tank having a tank valve on a first end thereof, the flame transfer member being flammable and suitably extending a second end of the high-pressure tank to the tank valve, so that when a fire occurs, the flame transfer member burns creating flames and suitably transfers heat generated by the flames from an origin of the fire to a PRD (pressure relief device) provided on the tank valve.

According to preferred embodiments of the present invention, when a fire occurs inside a vehicle or nearby the vehicle, preferably, when a local fire occurs, a PRD can be suitably reliably operated, thus preventing a high-pressure gas tank from being suitably damaged, thereby ensuring the fire safety of a high-pressure gas storage system of the vehicle using high-pressure gas.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 illustrates exemplary views of a high-pressure hydrogen storage system for fuel cell vehicles and an enlargement of a PRD provided on a tank valve of the storage system;

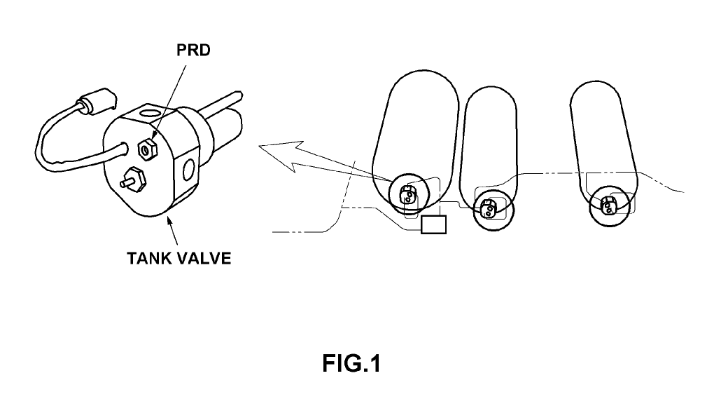

FIG. 2 is an exemplary sectional view showing the operation of a PRD used in a tank valve of a typical high-pressure gas storage system;

FIG. 3 is an exemplary side sectional view illustrating a fire safety apparatus for a high-pressure gas storage system, according to an embodiment of the present invention;

FIG. 4 is an exemplary front view showing the fire safety apparatus from the direction indicated by the arrow “A” of FIG. 3;

FIG. 5 is an exemplary schematic view showing the operation of the fire safety apparatus of FIG. 3; and

FIG. 6 is an exemplary schematic view showing the operation of a fire safety apparatus, according to another embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention includes a fire safety apparatus for a high-pressure gas storage system, comprising a flame transfer member provided outside a high-pressure tank, having a tank valve on a first end thereof, the flame transfer member being flammable and extending a second end of the high-pressure tank to the tank valve,

In one embodiment, a PRD (pressure relief device) is provided on the tank valve.

In another further embodiment, a protector is provided between the flame transfer member and the high-pressure tank.

In another embodiment, the flame transfer member is made of plastic.

In a further embodiment, when a fire occurs, the flame transfer member burns creating flames and transfers heat generated by the flames from an origin of the fire to a PRD (pressure relief device) provided on the tank valve.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Furthermore, terms used in the description of the present invention are only for illustrative purpose rather than being for limiting the present invention. Expressions in a singular number include expressions of the plural so long as a clearly special meaning is not implied from the context.

In the description of the embodiments of the present invention, overlapping explanations of a construction the same as that of conventional techniques may be omitted.

Preferably, the present invention provides a fire safety apparatus for a high-pressure gas storage system which can reliably operate a PRD when a fire occurs in a vehicle, in particular, even when a confined fire occurs, thus preventing a high-pressure gas tank (hereinafter, referred to as ‘high-pressure tank’) from exploding, thereby suitably ensuring the fire safety of the high-pressure gas storage system. In preferred embodiments, the present invention is characterized in that a flame transfer member having superior flammability is suitably used such that even when a confined fire occurs, the PRD operates reliably.

Hereinafter, preferred embodiments of the present invention will be described in detail with reference to the attached drawings.

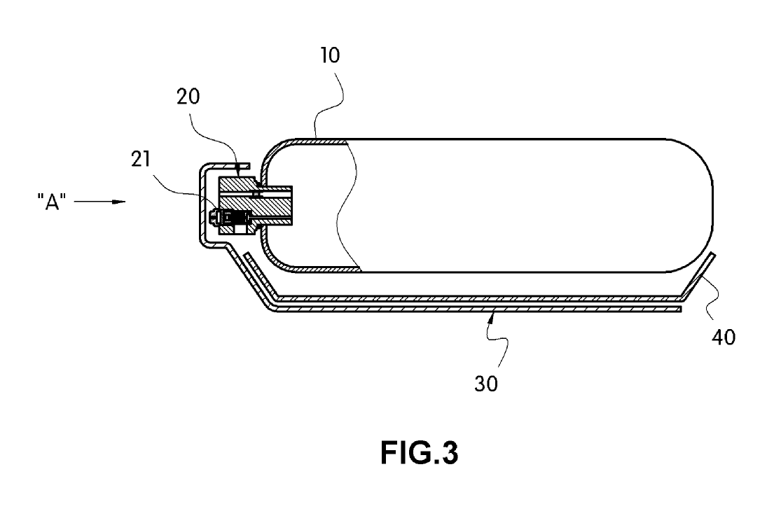

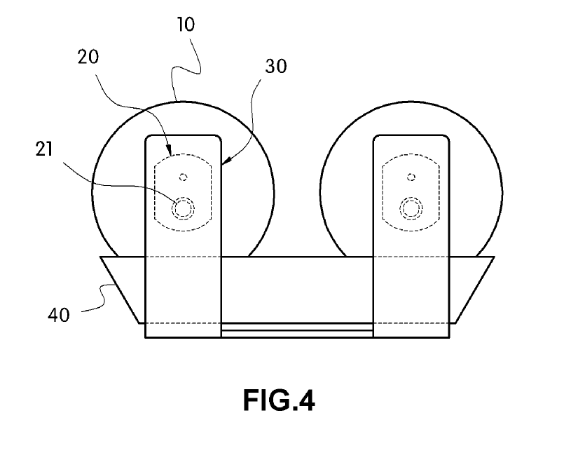

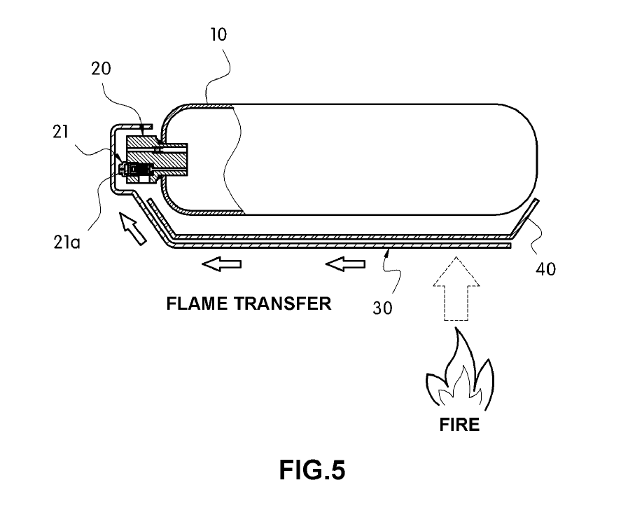

According to certain preferred embodiments of the present invention, for example as shown in FIG. 3, FIG. 3 is an exemplary side sectional view illustrating a fire safety apparatus for a high-pressure gas storage system, according to an embodiment of the present invention. In a further preferred embodiments, FIG. 4 is a front view showing the fire safety apparatus from the direction indicated by the arrow “A” of FIG. 3. In another further preferred embodiment, FIG. 5 is a schematic view showing the suitable operation of the fire safety apparatus.

The fire safety apparatus for the high-pressure gas storage system according to preferred embodiments of the present invention includes a protector 40 and a flame transfer member 30. Preferably, for example as shown in FIG. 3, the high-pressure gas storage system is schematically expressed by a high-pressure tank 10 and a tank valve 20 provided with a PRD 21.

According to certain preferred embodiments, the high-pressure gas storage system suitably compresses gas fuel (for example, hydrogen) at high pressure and suitably stores it or supplies it to a desired location. Preferably, the high-pressure gas storage system includes the high-pressure tank 10 which contains high-pressure gas fuel therein, the tank valve 20 which suitably controls the supply of high-pressure gas, and a mounting frame (not shown) which is suitably mounted to a vehicle body.

In certain preferred embodiments, the protector 40 functions to suitably protect the high-pressure gas storage system from a stone or the like on a road when the vehicle travels. In further preferred embodiments of the present invention, the protector 40 functions not only to suitably protect the high-pressure gas storage system from the shock of a collision but also to suitably prevent flames from being directly applied to the high-pressure tank 10.

Preferably, when a fire occurs, the flame transfer member 30 functions to rapidly transfer flames, in other words, heat, to the PRD 21 from the origin of the fire such that the PRD 21 operates rapidly. Preferably, to achieve this purpose, the flame transfer member 30 is made of plastic which can suitably easily burn to rapidly transfer flames to the PRD 21.

According to preferred exemplary embodiments, in the fire safety apparatus for the high-pressure gas storage system according to the present invention, for example as shown in FIG. 3, the flame transfer member 30 is suitably disposed below the protector 40 which encompasses the lower portion of the high-pressure tank 10. Preferably, the flame transfer member 30 which is suitably disposed outside the protector 40 extends to the tank valve 20 having the PRD 21 in the longitudinal direction of the high-pressure tank 10 along the lower surface of the high-pressure tank 10.

According to other further embodiments, the flame transfer member 30 suitably extends from the opening-side end of the high-pressure tank 10, to which the tank valve 20 is mounted, to the other end thereof. Accordingly, although a fire occurs near any portion of the high-pressure tank 10, flames can be directly transferred to the PRD 21 such that PRD 21 rapidly responds to the fire, thus suitably preventing the high-pressure tank 10 from being damaged before the PRD 21 is operated.

In certain exemplary embodiments, for example in the case where the high-pressure gas storage system has several high-pressure tanks 10, each high-pressure tank 10 may preferably have a flame transfer member 30. According to other preferred embodiments of the present invention, for example as shown in FIG. 4, the flame transfer members 30 which are preferably provided around the high-pressure tanks 10 may be suitably integrated with each other. In this case, although a fire occurs near any high-pressure tank 10 of the high-pressure gas storage system, flames are directly transferred to all the high-pressure tanks 10 such that gas can be rapidly and safely discharged from all the high-pressure tanks 10.

In further preferred embodiments, for example as shown FIG. 4, the flame transfer member 30 preferably extends from the opening-side ends of the high-pressure tanks 10, that is, preferably from the vicinities of the tank valves 20, to the other ends of the high-pressure tanks 10. Preferably, below the protector 40, the flame transfer member 30 suitably extends in the direction in which the high-pressure tanks 10 are disposed in a row. In further preferred embodiments, portions of the flame transfer member 30 which preferably extend from its lower portion disposed below the protector 40 to the tank valves 20 have widths suitably corresponding to the relative tank valves 20 such that flames can be transferred only to the tank valves 20 to suitably prevent the flames from being directly applied to the high-pressure tanks 10.

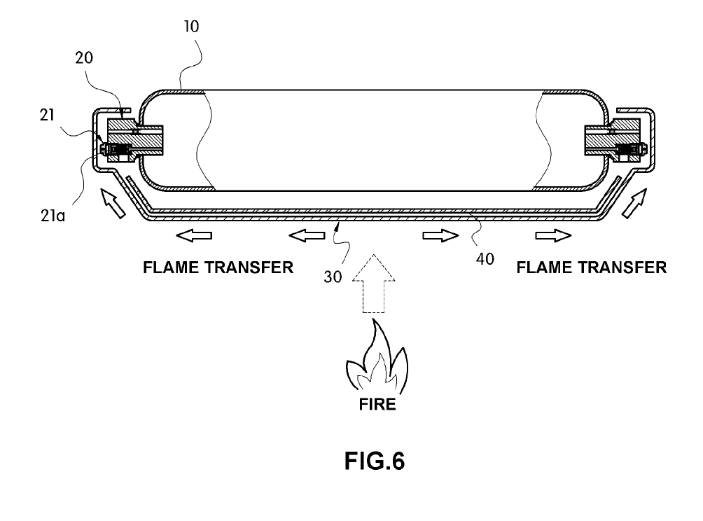

According to certain preferred embodiments of the present invention, for example as shown in FIG. 6, FIG. 6 is a schematic view showing the operation of a fire safety apparatus.

For example, as shown in FIG. 6, in the case where a high-pressure tank 10 is relatively long, PRDs 21 are preferably provided on both ends of the high-pressure tank 10. In this case, a flame transfer member 30 preferably extends in the longitudinal direction of the high-pressure tank 10 along the lower surface thereof to both ends of the high-pressure tank 10 such that it suitably covers tank valves 20 provided with the PRDs 21.

The operation of the fire safety apparatus according to certain exemplary embodiments of the present invention are explained herein.

According to certain exemplary embodiments, if a fire occurs inside the vehicle or near the vehicle, for example, as shown in FIGS. 5 and 6, a confined fire occurs, the flame transfer member 30 which is flammable is rapidly burned outside the high-pressure tank 10 and the protect 40 and thus applies flames, i.e., heat, to the tank valve 20.

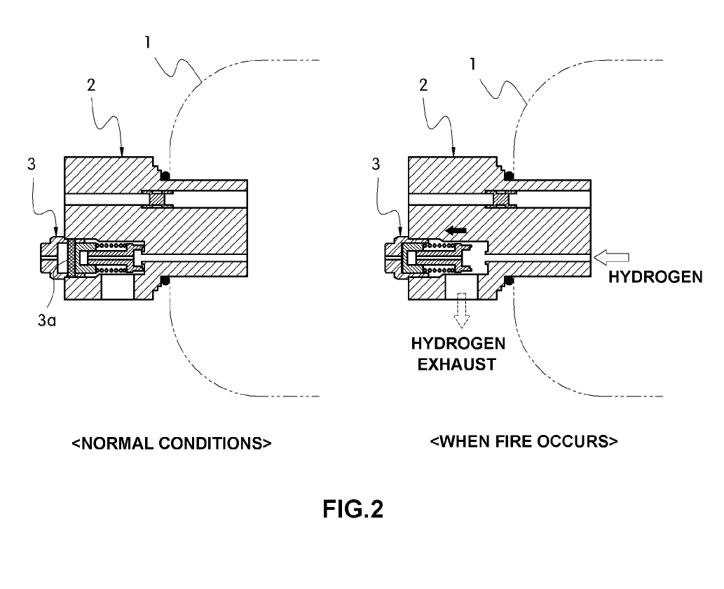

Accordingly, the temperature of the vicinity of the PRD 21 is suitably increased. Preferably, when the temperature of the vicinity of the PRD 21 reaches a suitably predetermined temperature (for example, about 110° C.), a fusible metal piece 21a which is provided in the PRD 21 is suitably fused. According to further preferred embodiments, high-pressure gas is suitably discharged from the high-pressure tank 10 (refer to FIG. 2).

Accordingly, in the present invention, if a fire occurs inside the vehicle or near the vehicle, the flame transfer member 30 is rapidly burned, thus transferring flames to the PRD 21. Preferably, according to the present invention as described herein, even if a confined fire occurs, the PRD 21 can be reliably operated. Accordingly, the present invention can suitably enhance the reliability of the operation of the fire safety apparatus. Furthermore, thereby, the fire safety apparatus can suitably prevent the high-pressure tank 10 from being exploded by heat, so that the fire safety in a fuel storage system for vehicles using high-pressure gas can be suitably ensured.

In further preferred embodiments, because the general construction used in the existing high-pressure gas storage system including the PRD 21 and the protector 40 can be used and the flame transfer member 30 is made of plastic, the fire safety apparatus of the present invention can be easily implemented. In further preferred embodiments, the installation of an additional structure for ensuring the fire safety of the high-pressure gas storage system can be suitably simplified, thus markedly reducing the production cost.

Further, the present invention has not only the technical advantage of ensuring the fire safety but also the intangible advantage of improving the safety understanding of consumers for introduction of a new technology such as a fuel cell vehicle using high-pressure gas.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A fire safety apparatus for a high-pressure gas storage system, comprising: a flame transfer member provided outside a high-pressure tank having a tank valve on a first end thereof, the flame transfer member being flammable and extending from a second end of the high-pressure tank to the tank valve, so that when a fire occurs, the flame transfer member burns creating flames and transfers heat generated by the flames from an origin of the fire to a PRD (pressure relief device) provided on the tank valve.

2. The fire safety apparatus of claim 1, wherein a protector is provided between the flame transfer member and the high-pressure tank.

3. The fire safety apparatus of claim 1, wherein the flame transfer member is made of plastic.

4. A fire safety apparatus for a high-pressure gas storage system, comprising: a flame transfer member provided outside a high-pressure tank, having a tank valve on a first end thereof, the flame transfer member being flammable and extending from a second end of the high-pressure tank to the tank valve.

5. The fire safety apparatus for a high-pressure gas storage system of claim 4, wherein a PRD (pressure relief device) is provided on the tank valve.

6. The fire safety apparatus for a high-pressure gas storage system of claim 4, wherein when a fire occurs, the flame transfer member burns creating flames and transfers heat generated by the flames from an origin of the fire to a PRD (pressure relief device) provided on the tank valve.
